(19) United States
(12) Patent Application Publication
(10) Pub. No.: US 2010/0200348 A1
(43) Pub. Date: Aug. 12, 2010

(54) LIQUID DAMPER FOR REDUCING VERTICAL AND/OR HORIZONTAL VIBRATIONS IN A BUILDING OR MACHINE STRUCTURE

(76) Inventors: Michael Reiterer, Wien (AT); Andreas Kluibenschedl, Telfs (AT)

Correspondence Address: COLLARD & ROE, P.C., 1077 NORTHERN BOULEVARD, ROSLYN, NY, 11576, US

(21) Appl. No.: 12/733,827

(22) PCT Filed: Sep. 26, 2008
(86) PCT No.: PCT/EP2008/008207

§ 371 Date: Mar. 23, 2010

(30) Foreign Application Priority Data
Sep. 27, 2007 (AT) A 1533/2007

(51) Int. Cl. F16F 9/00

(52) U.S. Cl. 188/378

(57) ABSTRACT

In a liquid damper for reducing vertical and/or horizontal vibrations in a building or machine structure, having at least two chambers (1, 2) partly filled with liquid (3), which communicate with one another at their lower ends, whereby at least one chamber (1) is sealed off in airtight manner at its upper end, so that a sealed air space (V₀) is formed above the liquid (3), and at least one other chamber (2) is at least partly open at its upper end, the sealed air space (V₀) is divided into at least two partial air spaces (V₀₁ to V₀ₙ), whereby one partial air space (V_{N}) lies directly above the liquid (3), and one or more partial air spaces (V₀₂ to V₀ₙ) are connected with the partial air space (V₀₁) that lies directly above the liquid (3), or with the adjacent partial air space (V₀₂ to V₀ₙ), in each instance, by way of openings (7), whereby these openings (7) can be closed off, to form a seal, independent of one another.

The invention relates to a liquid damper for reducing vertical and/or horizontal vibrations in a building or machine structure, having at least two chambers partly filled with liquid, which communicate with one another at their lower ends, whereby at least one chamber is sealed off in airtight manner at its upper end, so that a sealed air space is formed above the liquid, and at least one other chamber is at least partly open at its upper end.

### STATE OF THE ART

The use of tuned mass dampers, as described in detail by Petersen, C., (2001). Schwingungsdämpfer im Ingenieurbau [Vibration Dampers in Construction Engineering]. 1^{st} edition, publisher: Maurer Söhne GmbH & Co. KG, Munich, ISBN 3-00-008059-7, is the state of the art and is successfully used to reduce vertical vibrations in building and machine structures. So-called pendulum dampers are used to damp horizontal vibrations. The principle of these two types of dampers is based on optimal tuning of the design parameters (inherent frequency and damping) to a selected inherent frequency of the vibration-susceptible structure being considered. Subsequent changes in the optimal design parameters are only possible with significant effort, for example by means of replacing spring elements and/or changing the vibrating mass.

As an alternative to tuned mass dampers, there are so-called liquid dampers that consist of a U-shaped pipe system partly filled with liquid. Preliminary theoretical studies of fluid dampers were carried out for horizontal and vertical vibrations by Sun et al. (Sun, L. M., Fujino, Y., Koga, K. (1995). A Model of Tuned Liquid Dampers for Suppressing Pitching Motions of Structures. Earthquake Engineering and Structural Dynamics, Vol. 24, p. 625-636; and Sun, L. M., Nakaoka, T., et al. (1990). Tuned liquid damper for suppressing vertical vibration. In: Proc. 45^{th} JSCE annual meeting, Vol. 1, p. 978-979 (in Japanese)). A comprehensive study of liquid dampers for reducing horizontal bridge vibrations was carried out by Reiterer and Ziegler (Reiterer, M., Ziegler, F. (2006). Control of Pedestrian-induced Vibrations of Long Span Bridges. Journal of Structural Control & Health Monitoring. John Wiley & Sons, Ltd. ISSN 1545-2255, Vol. 13, No. 6, p. 1003-1027).

The following patents are available with regard to liquid dampers:

D1: JP 10220522 A (MITSUBISHI HEAVY IND LTD), Aug. 21, 1998

D2: AT 201870 B1 (TECHNISCHE UNIVERSITAT WIEN [TECHNICAL UNIVERSITY OF VIENNA]), Aug. 15, 2007

D3: JP 9151986 A (MITSUBISHI HEAVY IND LTD), Jun. 10, 1997
D4: JP 5248491 A (MITSUBISHI HEAVY IND LTD), Sep. 24, 1993

The document D1 describes a device for vibration damping having a U-shaped tank that is filled with a liquid in its bottom region, and possess only a single gas space (on the left or on the right) above the liquid, the pressure of which spaces is controlled by way of an inlet/outlet valve, with expenditure of energy.

The document D2 describes a liquid damper having two chambers, both of which are sealed in gastight manner relative to the surroundings, or at least one of which is structured symmetrical to the vertical axis of the liquid damper, preferably symmetrical to the vertical axis of the first chamber. This document furthermore discloses an adaptation of the desired damping behavior by means of controlled feed and removal of gas in at least one of the gas spaces, but this causes practical difficulties on the part of the energy requirement for control of the feed and removal of gas.

The document D3 describes a purely passive system having an air chamber situated above the liquid surface on the left side and on the right side, in each instance. Furthermore, a chamber is known from the document D3 in which an exit that can change in terms of its passage area is disposed on the end that is open toward the top.

The document D4 also describes a purely passive system, where the chambers disposed above the liquid are sealed off tightly toward the top, by way of a valve. The valves lead directly to the outside and presumably serve for pressure equalization in the event of temperature changes.

It is the task of the present invention to create a liquid damper that allows non-problematical adaptation of the damping behavior to the load on a building or machine structure to be expected, with little expenditure of energy.

The task is accomplished in that in the case of the liquid damper indicated initially, only one of the two chambers is sealed off in airtight manner, and the second chamber has an air exit opening that points upward. The sealed air space is divided into at least two partial air spaces, whereby one partial air space lies directly above the liquid, and one or more partial air spaces are connected with the partial air space that lies directly above the liquid, or with the adjacent partial air space, in each instance, by way of openings, whereby these openings can be closed off, to form a seal, independent of one another.

In this connection, the partial air spaces of the tightly sealed chamber can lie in series, one on top of the other, or parallel, next to one another, and can be configured as rectangular or round pipe chambers.

By means of opening and closing the openings, the total volume of the partial air space situated directly above the liquid and of partial air spaces communicating with it can be changed, and thus the inherent frequency of the liquid damper can be changed.

In contrast to the state of the art, the present invention works without controlled feed and removal of gas. The damper frequency is set with significantly less expenditure of energy, by way of the suitably selected size of the total volume situated above the liquid (sum of the open air chambers switched in parallel or in series). The optimal damper damping is set, in the present invention, by way of a suitable selection of the air exit opening, which can be adaptively changed in terms of its passage area.

Valves that can preferably be controlled by way of a controller, for example by way of a microcontroller, are built into the openings.

Preferably, the chamber having the end open at the top has an exit that can be changed in terms of its passage area, which is preferably a throttle device that can be controlled by way of a controller, such as the aforementioned microcontroller. Damping adaptation to the load can take place by means of changing the passage area.

To reinforce the damping effect, the use of liquids having a density ρ>1000 kg/m³ is advantageous. In this connection, liquid media having a density ρ=1000-5000 kg/m³ (for example bentonite ρ=approximately 2300 kg/m³) are particularly provided.

When using the liquid damper according to the invention, the inherent frequency of the building and machine structure under an imminent load is calculated, the optimal inherent frequency of the liquid damper in this connection is determined, and the total volume of the partial air space situated directly above the liquid and of the partial air spaces that communicate with it is approximated as well as possible to the optimal volume that results from the optimal inherent frequency, in that openings between the partial air spaces are opened and/or closed, preferably by way of valves controlled by a controller.

Furthermore, preferably the optimal damping under an imminent load is calculated and the area of the exit of the at least partly open chamber for optimal damping is set, preferably by way of a throttle device controlled by a controller. The data for adaptation of the area of the exit to the optimal damping for different loads can be determined experimentally, in advance, for every liquid damper.

As a basis for calculating the inherent frequency and the optimal damping of the building or machine structure under an imminent load, it is advantageous to determine the weight of the load-causing elements, particularly by way of a dynamic scale.

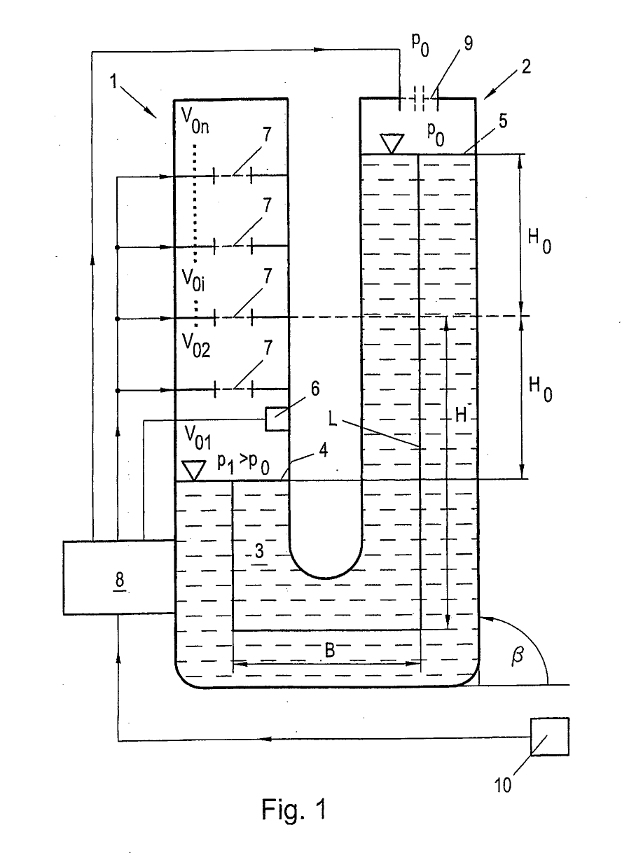

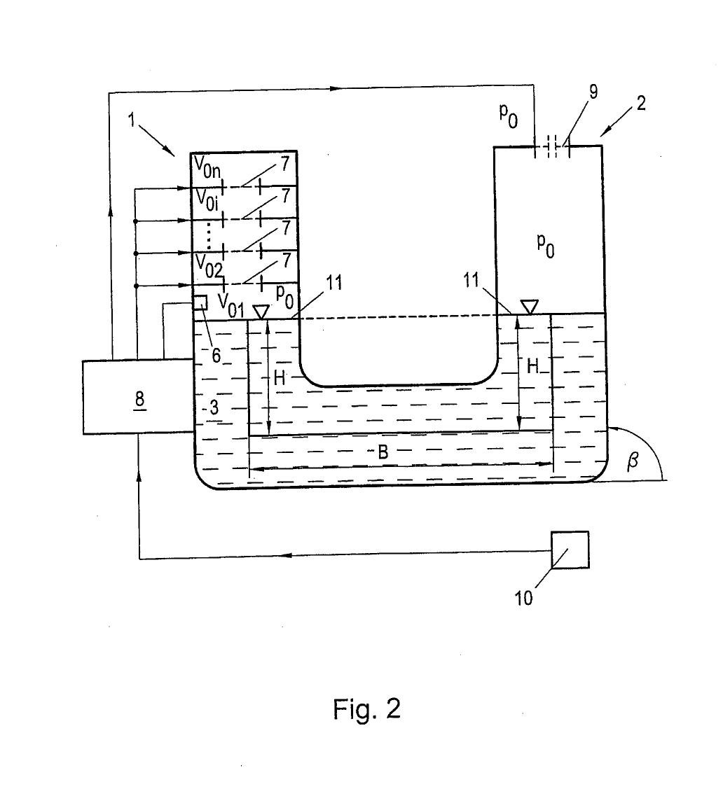

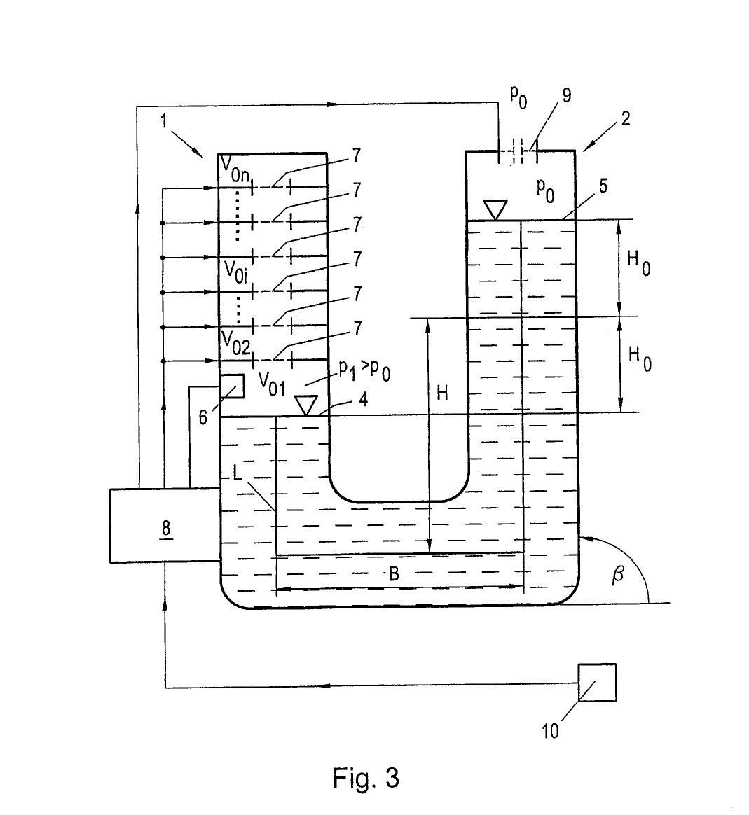

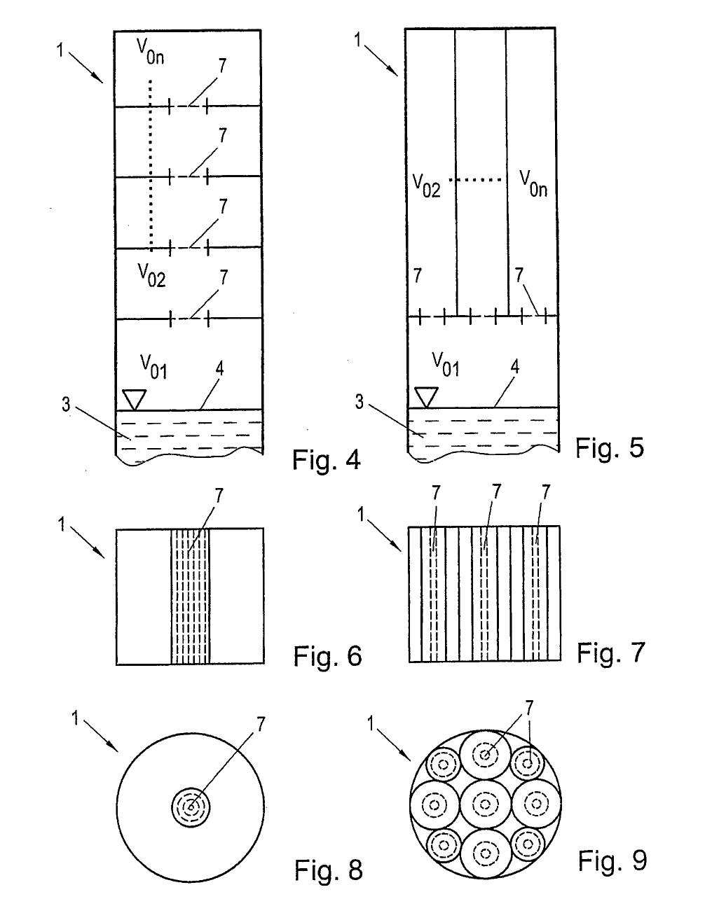

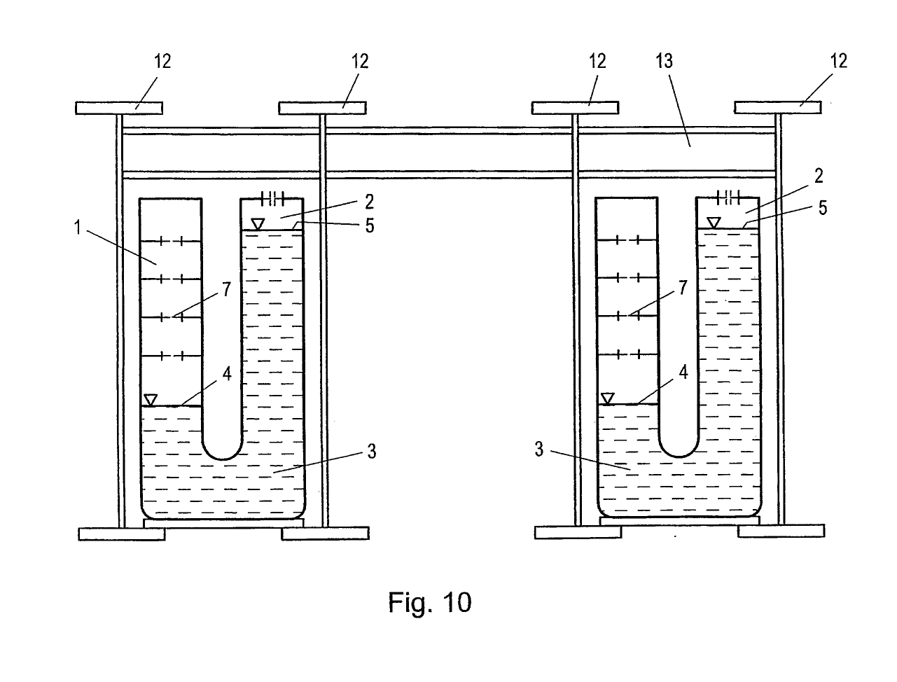

Now, the invention will be illustrated using the attached drawings, in which FIG. 1 shows a liquid damper for vertical vibrations, FIG. 2 shows a liquid damper for horizontal vibrations, and FIG. 3 shows a liquid damper for horizontal and vertical vibrations, and in which FIGS. 4 and 5 show two possible embodiments of the airtight, sealed end of liquid dampers according to the invention, and FIGS. 6 to 9 show cross-sections through possible embodiments of the airtight, sealed end of liquid dampers according to the invention, and in which finally, FIG. 10 shows the cross-section through a bridge structure with liquid dampers affixed to it.

The method of construction of the liquid damper for damping horizontal and/or vertical vibrations is characterized by the adaptation of optimal inherent frequency and damping, controlled by way of a microcontroller. The liquid damper consists of a pipe system partly filled with liquid having the density ρ, having the cross-section A of any desired shape. Fundamentally, a distinction is made in the description of the invention between the following three types of liquid dampers:
vertical liquid damper (FIG. 1),
horizontal liquid damper (FIG. 2),
combined horizontal and vertical liquid damper (FIG. 3).

Vertical Liquid Damper (FIG. 1)

The vertical liquid damper is used for damping preferably vertical structure vibrations. The pipe system, partly filled with liquid 3, consists of a pipe part 1 sealed in airtight manner, whereby the air space having the volume V₀ above the liquid level is divided into partial air spaces having the partial volumes V₀₁ to V₀ₙ. In the airtight, sealed pipe part 1, the excess pressure p₁=p₀+2 ρgH₀ is imposed, where p₀ is the atmospheric pressure and 2H₀ is the dimension by which the liquid level 4 in the sealed pipe part 1 is offset relative to the liquid level 5 in the open pipe part 2. The change in the excess pressure over time is monitored using a pressure sensor 6. In this way, it is also possible to determine the static and dynamic liquid level variations.

Placement of the partial air spaces is possible both in a serial circuit (FIG. 4) and in a parallel circuit (FIG. 5), whereby rectangular (FIG. 6 and FIG. 7) and round pipe chambers (FIG. 8 and FIG. 9) can be structured. In the case of the serial circuit, one chamber is connected with the next in line by way of a valve 7 that can be opened. In the case of the parallel circuit, the chambers are disposed next to one another. Opening and closing of the chambers is actively controlled by way of a microcontroller 8. The number of open chambers and thus the currently available air volume V are optimally adjusted as a function of the desired inherent frequency (=first design parameter) of the liquid damper. The relationship between opening size of the throttle and the resulting liquid damping was investigated in experiments, for flowing media, and listed in tables by Fried, E., Idelchik, I. E. (1989). Flow Resistance: a Design Guide for Engineers, Hemisphere, N.Y.

The second pipe part 2 of the vertical liquid damper is structured to be partly open. Here, the liquid level 5 is offset by the dimension 2H₀ relative to the sealed pipe part 1, in the vertical direction. Above the liquid level 5, there is an air volume that has the natural atmospheric pressure p₀ imposed on it. In the event of movement of the liquid column, the air can flow out upward by way of a variable throttle device. The size of the throttle opening 9 at any time is optimally adjusted as a function of the desired liquid damping (=second design parameter), by way of a microcontroller 8.

The microcontroller 8 of the vertical liquid damper is coupled with a dynamic scale 10 and/or to any desired system for determining weight (for example weigh-in-motion system). The change in inherent frequency and thus the size of the additional load are determined by way of an acceleration sensor, as a function of the different dynamic load states of the structure to be damped (no load, partial load, full load). The weight-in-motion system is disposed in front of bridges, for example, and allows a determination of axle loads and thus an advance calculation of the changed inherent frequency of the bridge. The determination of the current weight by way of the dynamic scale 10 and the transmission of the data to the microcontroller 8 allow calculation of the optimal inherent frequency and damping of the liquid damper. The optimal inherent frequency and damping are then set by way of a suitable selection of the number of open partial air spaces and by way of the opening width of the throttle device 9.

The linear:inherent frequency of the vertical liquid damper results from use of the non-stationary Bernoulli equation in a moving reference system along a relative non-compressible flow line,

$${f}_{A} = \frac{1}{2 π} \sqrt{\frac{2 g}{L} [ sin β + \frac{{nh}_{0}}{2 {H}_{a}} ( 1 + \frac{2 {H}_{0}}{{h}_{0}} ) ]} , g = 9 , 81 m / {s}^{2} , {h}_{0} ≅ 10 m , \qquad ( 1 )$$

where ₀=p₀/ρg refers to the liquid column equivalent to the atmospheric pressure p₀, and 1≦n≦1.4 refers to the exponent of the polytropic gas compression, inserted in linearized manner. The total length of the liquid thread and the incline angle of the vertical pipe parts are designated as L and β. The imaginary height of the air spring Hₐ=ΣV₀ᵢ/A that occurs in the airtight, sealed pipe part is the significant influence parameter on the inherent frequency of the vertical liquid damper. The active control of the inherent frequency takes place by means of activation of an optimal number of partial air spaces switched in series or in parallel, by way of valves 7 that can be opened.

The second significant design parameter of the vertical liquid damper is liquid damping. This is defined with the linearized Lehr damping dimension ζ_{A}. Active regulation of the liquid damping to the optimal value also takes place using the microcontroller 8, by way of a throttle device 9. The size of the throttle opening related to the linearized damping dimension ζ_{A} can be determined experimentally, in advance, for every liquid damper.

The effectiveness of the vertical liquid damper is defined by way of the geometry factor kᵥ=2H₀ sin β/L. The greatest possible initial deflection H₀ in the static rest position as well as β=π/2 are therefore advantageous. The active mass of the vertical liquid damper is defined as mA=kᵥ m_{f}, where m_{f}=ρ A L.

Horizontal Liquid Damper (FIG. 2)

The horizontal liquid damper is used for damping preferably horizontal structure vibrations. The pipe system, partly filled with liquid 3, consists of a pipe part 1 sealed in airtight manner, whereby the air space having the volume V₀, above the liquid level, is divided into partial air spaces having the partial volumes V₀₁ to V₀ₙ. In the static rest position of the liquid level 11, the natural atmospheric pressure is imposed on both sides, i.e. no excess pressure is in effect. The pressure sensor 6 affixed within the airtight, sealed pipe part 1 yields the value of the pressure change when liquid vibrations occur. The remaining details concerning the embodiment and control of the horizontal liquid damper are analogous to the vertical liquid damper.

The linear inherent frequency of the horizontal liquid damper results from use of the non-stationary Bernoulli equation in a moving reference system along a relative non-compressible flow line,

$${f}_{A} = \frac{1}{2 π} \sqrt{\frac{2 g}{L} [ sin β + \frac{{nh}_{0}}{2 {H}_{a}} ]} , g = 9 , 81 m / {s}^{2} , {h}_{0} ≅ 10 m , \qquad ( 2 )$$

where h₀=p₀/ρg refers to the liquid column equivalent to the atmospheric pressure p₀, and 1≦n≦1.4 refers to the exponent of the polytropic gas compression, inserted in linearized manner. The total length of the liquid thread and the incline angle of the vertical pipe parts are designated as L and β. The imaginary height of the air spring Hₐ=ΣV_{0f}/A that occurs in the airtight, sealed pipe part is the significant influence parameter on the inherent frequency of the vertical liquid damper.

The effectiveness of the horizontal liquid damper is defined by way of the geometry factor k_{H}=(B+2H cos β)/L. The greatest possible horizontal length B in the static rest position is therefore advantageous. The active mass of the horizontal liquid damper is defined as mA=k_{H} m_{f}.

Combined Vertical and Horizontal Liquid Damper (FIG. 3)

The combined vertical and horizontal liquid damper is used for damping vertical and/or horizontal structure vibrations. Fundamentally, this is a combination of the two liquid dampers described above, where the geometry is selected in such a manner that the most optimal damping of vertical and/or horizontal vibrations is possible. The linear inherent frequency and embodiment are analogous to the vertical liquid damper, whereby the horizontal pipe part is lengthened. The major advantages of this liquid damper are:
When coupled vertical and horizontal vibrations occur, it is possible to optimally damp the coupled vibration with a single liquid damper.
Critical inherent frequencies with related vibration forms in the vertical or horizontal direction can be excited as a function of the load (force direction and exciter frequency). The inherent frequency of the liquid damper can be optimally tuned to the vertical or horizontal vibration by means of a suitable selection of the number of open partial air spaces.

The effectiveness of the combined vertical and horizontal liquid damper is defined by way of the geometry factors kᵥ=2H₀ sin β/L and k_{H}=(B+2H cos β)/L. The possibility exists of weighting dominant vibrations in a specific direction with greater effectiveness.

Optimal Tuning of the Liquid Dampers

Optimal tuning of the liquid dampers takes place analogous to the conventional tuned mass damper as shown by Reiterer (Reiterer, M., Ziegler, F. (2006). Control of Pedestrian-induced Vibrations of Long Span Bridges. Journal of Structural Control & Health Monitoring. John Wiley & Sons, Ltd. ISSN 1545-2255, Vol. 13, No. 6, p. 1003-1027). The optimal design parameters for the tuned mass damper were first presented by Den Hartog (Den Hartog, J. P. (1936). Mechanische Schwingungen [Mechanical Vibrations]. Verlag von Julius Springer [publisher], Berlin), f*ₛ and M* refer to the linear inherent frequency and the modal mass of the structure,

$${δ}_{opt}^{*} = \frac{{f}_{A}^{*}}{{f}_{s}^{*}} = \frac{1}{1 + {μ}^{*}} , {ζ}_{A , opt}^{*} = \sqrt{\frac{3 {μ}^{*}}{8 ( 1 + {μ}^{*} )}} , {μ}^{*} = \frac{{m}_{A}^{*}}{{M}^{*}} \qquad ( 3 )$$

where δ*ₒₚₜ and ζ*_{A, opt} define the optimal frequency ratio and the optimal Lehr damping dimension of the equivalent linear tuned mass damper. For the calculation of the optimal design parameters of the liquid damper, the equivalent mass ratio is defined as follows,

$${μ}^{*} = \frac{{m}_{A}^{*}}{{M}^{*}} = \frac{{μK}^{2}}{1 + μ ( 1 - {K}^{2} )} , μ = \frac{{m}_{f}}{M} \cdot \qquad ( 4 )$$

For the dimension-free geometry factor k, the corresponding factors k_{V} and k_{H}, respectively, must be inserted. The optimal design parameters of the liquid damper are then defined as follows,

$${δ}_{opt} = \frac{{f}_{A}}{{f}_{S}} = \frac{{δ}_{opt}^{*}}{\sqrt{1 + μ ( 1 - {K}^{2} )}} , {ζ}_{A , opt} = {ζ}_{A , opt}^{*} \cdot \qquad ( 5 )$$

Steel Bridge as an Application Example

As a practical example, a one-field steel bridge having an open cross-section and a span width of 1=30 m will be considered. The longitudinal beams of the bridge consist of I profiles having a height of 1.2 m, which are connected with one another by way of cross-beams. The mass per length unit and the bending stiffness of the bridge amount to ρA=2670 kg and EJ=1.1×10¹⁰ N/m². Subsequently, two different dynamic load states, for example due to a train passing over the bridge, are examined:
Case 1: Additional mass per length unit (ρA)_{ZUS1}=700 kg/m
Case 2: Additional mass per length unit (ρA)_{ZUS2}=2100 kg/m
Case 3: No load on bridge

The state “no load on bridge” is examined with regard to decay of bridge vibrations, for example after a train has passed over or due to excitation by gusts. The modal (moving) masses of the bridge therefore amount to the following: M_{ZUS1}=└ρA+(ρA)_{ZUS1}┘l/2=50550 kg, M_{ZUS2}=└ρA+(ρA)_{ZUS2}┘l/2=71550 kg and M=ρAl/2=40050 kg for the one-field system (see Reiterer, M. (2004). Schwingungsdämpfung von Baukonstruktionen, insbesondere von Brücken [Vibration Damping of Built Structures, particularly of Bridges]. Dissertation, Faculty of Construction Engineering, Technical University of Vienna, Institute for General Mechanics). On the basis of the different load states, the basic frequencies of the bridge with a dominantly vertical vibration form are (see also Reiterer, M. (2004)):
Case 1: Basic frequency vertical f_{S, ZUS1}=3.15 Hz
Case 2: Basic frequency vertical f_{S, ZUS2}=2.65 Hz
Case 3: Basic frequency vertical f_{S}=3.54 Hz

In order to damp the bridge vibrations, a vertical liquid damper is installed, whereby the total mass of the liquid is selected to be m_{f}=800 kg. The vibrations of all three different load states (Case 1 to 3) are reduced with a single liquid damper. The ratios of liquid mass to modal (moved) bridge mass are obtained as a function of the dynamic load state being considered, according to Equation (4), and are μ_{ZUS1}=1.6%, μ_{ZUS2}=1.2%, and μ=2.0%. The flow thread length, the vertical liquid level height difference, and the incline angle of the vertical pipe shanks are selected to be L=1.5 m, H₀=0.3 m, and β=π/2. The cross-sectional area of the pipe system is therefore A=0.53 m². The geometry factor of the vertical liquid damper turns out to be k_{V}=0.4 (see above).

After the configuration of the vertical liquid damper has been determined, the optimal design parameters of the liquid damper as a function of the dynamic load state, in each instance, can be determined by means of evaluating Equations (4), (3), and (5),
Case 1: f_{A, opt, ZUS1}=3.12 Hz, ζ_{A, opt}=3.1%
Case 2: f_{A, opt, ZUS2}=2.63 Hz, ζ_{A, opt}=2.7%
Case 3: f_{A, opt}=3.50 Hz, ζ_{A, opt}=3.4%

The imaginary height of the air spring to be set for the load state, in each instance, results from transformation of Equation (1) with n=1.2 and is
Case 1: H_{a, ZUS1}=0.23 m
Case 2: H_{a, ZUS2}=0.32 m
Case 3: Hₐ=0.18 m

The total height of the air spring in the airtight, sealed pipe part is therefore established at the maximal value of 0.32 m, and further subdivision of the air chambers takes place in the steps of 0.23 m and 0.18 m from the liquid level surface, measured in the static rest position. Thus, the related optimal inherent frequency of the liquid damper can be set as a function of the dynamic load state, in each instance, by way of activating the corresponding air volume.

Adjustment of the optimal liquid damping takes place by way of the variable throttle device on the open pipe part. The required size of the opening is determined by experiments.

1. Liquid damper for reducing vertical and/or horizontal vibrations in a building or machine structure, having at least two chambers partly filled with liquid, which communicate with one another at their lower ends, whereby at least one chamber is sealed off in airtight manner at its upper end, so that a sealed air space is formed above the liquid, and at least one other chamber is at least partly open at its upper end, wherein the sealed air space (V₀) is divided into at least two partial air spaces (V₀₁ to V₀ₙ), whereby one partial air space (V₀₁) lies directly above the liquid (3), and one or more partial air spaces (V₀₂ to V₀ₙ) are connected with the partial air space (V₀₁) that lies directly above the liquid (3), and/or with the adjacent partial air space (V₀₂ to V₀ₙ), in each instance, by way of openings (7), whereby these openings (7) can be closed off, to form a seal, independent of one another.

2. Liquid damper according to claim 1, wherein the partial air spaces (V₀₁ to V₀ₙ) are configured as rectangular or round pipe chambers.

3. Liquid damper according to claim 1, wherein valves that can be controlled by way of a controller (8) are built into the openings (7).

4. Liquid damper according to claim 1, wherein the chamber (2) with the end open at the top has an exit (9) that can be changed in terms of its passage area, in known manner.

5. Liquid damper according to claim 4, wherein the exit (9) that can be changed in terms of its passage area is a throttle device that can be controlled by way of a controller (8).

6. Liquid damper according to claim 1, wherein the fluid contained in the liquid damper has a density ρ>1000 kg/m³, preferably a density ρ=1000-5000 kg/m³.
